(19) United States
(12) Patent Application Publication
(10) Pub. No.: US 2026/0132895 A1
(43) Pub. Date: May 14, 2026

(54) AI-DRIVEN FACILITY SENSOR PLANNING AND METHANE LEAK DETECTION

(71) Applicant: Schlumberger Technology Corporation, Sugar Land, TX (US)

(72) Inventors: Sergey Skripkin, Oslo (NO); Katya Conte, Milan (IT)

(21) Appl. No.: 18/941,299

(22) Filed: Nov. 8, 2024

(51) Int. Cl. F17D 5/06; F17D 5/00

(52) U.S. Cl. CPC F17D 5/06; F17D 5/005

(57) ABSTRACT

A method for detecting a gas leak includes selecting locations for a plurality of simulated point sources of the gas leak at a site. The method also includes generating a plurality of physical dispersion models based upon the simulated point sources, a selected number of sensors that are configured to detect the gas leak, and selected locations of the sensors. The method also includes determining simulated measurements from the sensors at the selected locations using the plurality of physical dispersion models. The method also includes training one or more models based upon the simulated measurements. The method also includes receiving actual measurements from the selected number of the sensors at the selected locations. The method also includes predicting a location and/or a rate of the gas leak using the one or more trained models based upon the actual measurements.

### BACKGROUND

Methane is a colorless, odorless gas that is stable under a wide range of pressure and temperature conditions in the absence of other compounds. Methane is also the lightest and most abundant of the hydrocarbon gases and the principal component of natural gas. In addition, methane is also considered to be a greenhouse gas (GHG), and as such, the escape of methane into the atmosphere from a wellsite and/or facility should be limited. Therefore, what is needed is an improved system and method for determining where to place methane sensors and/or detecting methane leaks (e.g., using the sensors).

### SUMMARY

A method for detecting a gas leak is disclosed. The method includes selecting locations for a plurality of simulated point sources of the gas leak at a site. The method also includes generating a plurality of physical dispersion models based upon the simulated point sources, a selected number of sensors that are configured to detect the gas leak, and selected locations of the sensors. The method also includes determining simulated measurements from the sensors at the selected locations using the plurality of physical dispersion models. The method also includes training one or more models based upon the simulated measurements. The method also includes receiving actual measurements from the selected number of the sensors at the selected locations. The method also includes predicting a location and/or a rate of the gas leak using the one or more trained models based upon the actual measurements.

A computing system is also disclosed. The computing system includes one or more processors and a memory system. The memory system includes one or more non-transitory computer-readable media storing instructions that, when executed by at least one of the one or more processors, cause the computing system to perform operations. The operations include selecting locations for a plurality of simulated point sources of a gas leak at a site. The operations also include generating a plurality of physical dispersion models based upon the plurality of simulated point sources, a potential rate of the gas leak from the one or more of the plurality of simulated point sources, a selected number of actual sensors that are configured to detect the gas leak, and selected locations of the actual sensors. The operations also include determining simulated measurements from the actual sensors at the selected locations using the plurality of physical dispersion models. The operations also include training a machine learning (ML) regression algorithm to predict a location and/or a rate of the gas leak based upon the simulated measurements and the current atmospheric conditions. The operations also include training a ML classifier to predict a probability that the gas leak is coming from each of the plurality of simulated point sources based upon the simulated measurements and the current atmospheric conditions. The operations also include receiving actual measurements from the selected number of the actual sensors at the selected locations. The operations also include predicting the location and/or the rate of the gas leak using the trained ML regression algorithm and the trained ML classifier. The predicted location and/or the predicted rate are based upon the actual measurements.

A non-transitory computer-readable medium is also disclosed. The medium stores instructions that, when executed by one or more processors of a computing system, cause the computing system to perform operations. The operations include selecting locations for a plurality of simulated point sources of a gas leak at the site. The locations of the plurality of simulated point sources are randomly selected inside delimited areas of potential gas leaks. The site is a facility or a wellsite. The gas is methane. The operations also include receiving historical atmospheric conditions at the site. The historical atmospheric conditions include wind speed, wind direction, and solar irradiation. The operations also include performing a plurality of simulated iterations to determine an accuracy of detecting the gas leak at the site with a plurality of simulated sensors. Each iteration is performed with a different number of the simulated sensors and/or different locations of the simulated sensors. The accuracy is determined based upon the plurality of simulated point sources and the historical atmospheric conditions. The simulated sensors are located along and/or inside a perimeter of the site. The locations of the simulated sensors are determined in one dimension when the locations of the simulated sensors are exclusively along the perimeter. The locations of the simulated sensors are determined in two dimensions when one or more of the simulated sensors are located inside the perimeter. The operations also include displaying the accuracy of detecting the gas leak for each iteration. A chart displays the accuracy versus the number of the simulated sensors. A map displays the locations of the simulated sensors. The operations also include selecting the number of the simulated sensors based upon the accuracy. The operations also include selecting the locations of the selected number of the simulated sensors based upon an optimization strategy. The operations also include positioning the selected number of actual sensors at the selected locations. The operations also include receiving actual measurements from the selected number of the actual sensors at the selected locations. The operations also include generating a plurality of physical dispersion models based upon the plurality of simulated point sources, a potential rate of the gas leak from the one or more of the plurality of simulated point sources, the historical atmospheric conditions, the number of the actual sensors, and the locations of the actual sensors. Each of the plurality of physical dispersion models has randomly generated initial conditions. The initial conditions include one or more of the plurality of simulated point sources, current atmospheric conditions, and the potential rate of the gas leak. The operations also include determining simulated measurements from the actual sensors at the selected locations using the plurality of physical dispersion models. Self-correlated noise is added to each of the plurality of physical dispersion models and/or the simulated measurements. The operations also include training a machine learning (ML) regression algorithm to predict a location and/or a rate of the gas leak based upon the simulated measurements and the current atmospheric conditions. The operations also include training a ML classifier to predict a probability that the gas leak is coming from each of the plurality of simulated point sources based upon the simulated measurements and the current atmospheric conditions. The operations also include predicting the location and/or the rate of the gas leak using the trained ML regression algorithm and the trained ML classifier. The predicted location and the predicted rate are based upon the actual measurements. Predicting the location and the rate includes determining probabilities that the location of the gas leak is at each of the plurality of simulated point sources. The operations also include displaying the predicted location and the predicted rate of the gas leak.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for positioning sensors at a site and detecting a gas leak using the sensors, according to an embodiment.

FIG. 3 illustrates a plan view showing a sensor planning workflow, according to an embodiment.

FIG. 4 illustrates a chart displaying an accuracy of detection by the simulated sensors versus the number of the simulated sensors, according to an embodiment.

FIG. 5 illustrates a map displaying (e.g., optimal) locations of the simulated sensors, according to an embodiment.

FIG. 6 illustrates a graph showing the progression of the optimization of the number and/or placement of the sensors, according to an embodiment.

FIG. 7 illustrates a plan view of a physical dispersion model generated from point sources randomly positioned inside delimited areas of potential gas leaks, according to an embodiment.

FIG. 8 illustrates a plan view of a prediction from the ML classifier showing probabilities of leak source locations, according to an embodiment.

FIG. 9 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

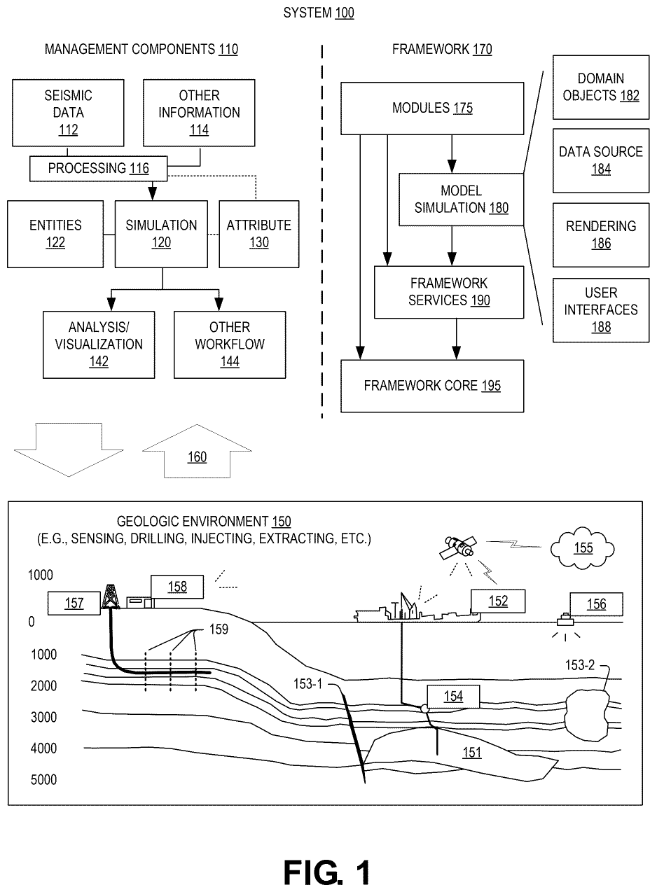

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### AI-Driven Facility Sensor Planning and Methane Leak Detection

The present disclosure may provide a system and method configured to detect, locate, and/or quantify methane leaks based on readings from point sensors that measure atmospheric methane concentrations and/or meteorological conditions. The system and method may also determine a plan for the sensors. This may include determining the optimal number and positions of sensors in a specific facility.

Leak identification works by first generating an ensemble of physical models showing a theoretical distribution of leaking gas concentrations under specific atmospheric conditions, leak locations, and leak rate. After that, leak identification and characterization may be performed via a family of methods, most of which use machine learning (ML) algorithms to directly map sensor readings to the most probable leak location and rate. In another embodiment, probabilistic ML methods may be used to predict probabilities of leaks occurring at specific locations.

The method described herein has built-in self-adaptation behaviour and automatically determines suitable parameters of ML algorithms and the size of underlying physical dispersion models. The method can either train ML models under known atmospheric conditions each time leak identification is performed, or the method can pretrain a large ML model capable of identifying leaks in uncertain weather conditions in real-time. Additionally, the method may determine confidence metrics for leak locations and rates. These metrics may be used to provide the user with detailed visual representation of the results.

The facility sensors planning solution described herein proposes a set of techniques to automatically optimize future performance of the abovementioned leak identification method under various atmospheric conditions. It finds the optimal placement for a fixed number of sensors for specific weather patterns, facility geometry, and equipment distribution. Various constrains may be honoured, such as exclusion zones and placement of sensors exclusively on the boundary of the facility.

The planning solution may be based on one or more different optimization strategies. Each strategy uses several statistical and ML-derived metrics to reduce optimization runtime while accurately solving the problem. First, optimization steps use unsupervised surrogate metrics which allow for efficient screening of parameter space. When optimization starts to converge to the location of potential solutions, metrics may be swapped from statistical to ML-derived. At the last stage of optimization, global stochastic optimizers may be replaced with local ones which allows for fine tuning of proposed solutions. Once optimization has converged, the system analyses the differences between the proposed solutions, determines a diverse set of potential sensors placements, and runs each of them through a full-scale validation by predictive ML models.

The method provides real-time optimization progress visualisation of multiple elements: potential point sources, optimization trajectories, current optimal solutions, relative importance of each sensor for overall system accuracy, and estimated runtime. The process may be repeated for different numbers of sensors. At the end, the user may be presented with a display of optimal system performance versus the number of sensors. This can then be used to determine the best trade-off between system accuracy and installation cost.

The ML method can deliver leak characterization in real-time after initial pretraining. The method optimizes the use of resources and computing power. The method does not involve retraining on the same data. Optimization strategies at the core of the planning solution are parameter-free, user friendly, maximize the probability of optimization success, and deliver results in a short period of time (e.g., 1 hour, 2 hours, etc.). The method thus provides automated accurate identification of methane leaks in industrial settings based on methane concentrations measured by the point sensors. Accurate and timely methane leak detection may minimize remediation cost. Optimal sensor placement and an optimal number of the sensors directly reduces installation and equipment costs.

### Exemplary Method

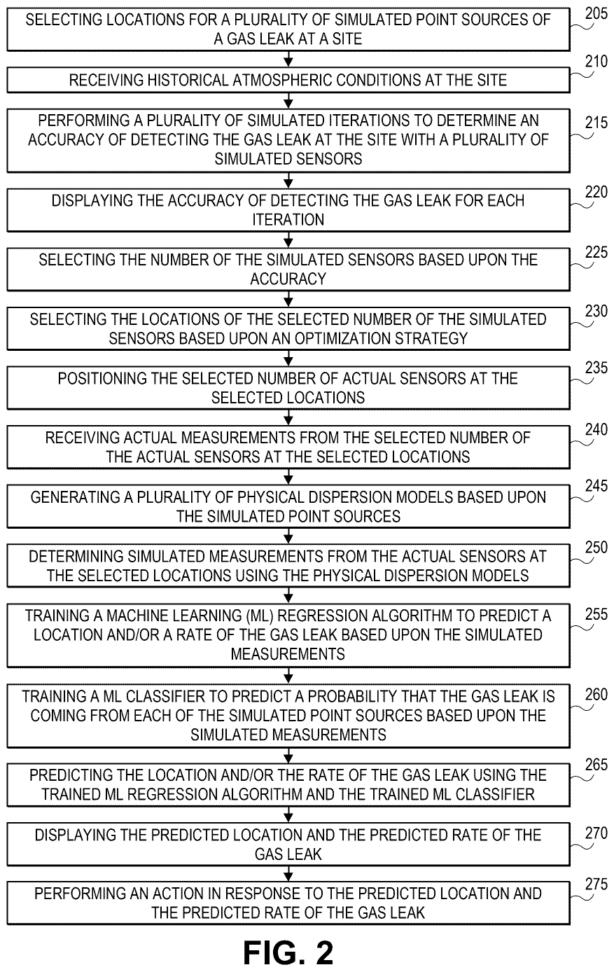

FIG. 2 illustrates a flowchart of a method 200 for positioning sensors at a site and detecting a gas leak using the sensors, according to an embodiment. An illustrative order of the method 200 is provided below; however, one or more portions of the method 200 may be performed in a different order, simultaneously, repeated, or omitted. At least a portion of the method 200 may be performed with a computing system 500 (described below).

The method 200 may include selecting locations for a plurality of simulated point sources at the site, as at 205. The locations of the simulated point sources may be randomly selected inside delimited areas of potential gas leaks. The site may be or include a facility or a wellsite. In an example, the gas may be or include methane and/or other greenhouse gases (GHG).

The method 200 may also include receiving historical atmospheric conditions at the site, as at 210. The historical atmospheric conditions may be or include wind speed, wind direction, solar irradiation, or a combination thereof.

The method 200 may also include performing a plurality of simulated iterations to determine an accuracy of detecting the gas leak at the site with a plurality of simulated sensors, as at 215. Each iteration may be performed with a different number of the simulated sensors and/or different locations of the simulated sensors. The accuracy may be determined based upon the simulated point sources and/or the historical atmospheric conditions. The simulated sensors may be located along and/or inside a perimeter of the site. The locations of the simulated sensors may be determined in one dimension when the locations of the simulated sensors are exclusively along the perimeter. The locations of the simulated sensors may be determined in two dimensions when one or more of the simulated sensors are located inside the perimeter.

The number of the simulated sensors and/or the locations of the simulated sensors are determined by performing one or more optimization strategies. A first optimization strategy may include running an optimizer based upon the locations of the simulated point sources and/or the historical atmospheric conditions. The optimizer may be run to identify a global optimum of multi-dimensional target functions. Running the optimizer may include determining a surrogate statistical target. The surrogate statistical target may be or include a number of non-null readings from the simulated sensors and/or a degree of cross-correlation in readings from the simulated sensors. Running the optimizer may also include switching the surrogate statistical target to a reduced regressor or classifier machine learning (ML) model. The first optimization strategy may also include determining a predetermined number of solutions of the number of the simulated sensors and/or the locations of the simulated sensors from the reduced regressor or the classifier ML model once global optimization has converged or reached a runtime limit. The first optimization strategy may also include running the predetermined number of solutions through ML validation.

A second optimization strategy may include generating a predetermined number of the simulated sensors at random locations. The second optimization strategy may also include determining the accuracy detecting the gas leak for each of the predetermined number of the simulated sensors at the random locations. The second optimization strategy may also include determining a predetermined number of the random locations based upon the accuracy. The second optimization strategy may also include enhancing each of the predetermined number of the random locations using a local optimizer. The second optimization strategy may also include validating each of the enhanced predetermined number of the random locations using the reduced regressor or the classifier ML model.

A third optimization strategy may include generating the predetermined number of the simulated sensors at the random locations. The third optimization strategy may also include determining a similarity measure for the random locations. The third optimization strategy may also include performing hierarchical clustering on the random locations. The hierarchical clustering may be performed with a number of clusters that is smaller than the predetermined number of the simulated sensors. The third optimization strategy may also include randomly selecting one of the random locations from each cluster. The third optimization strategy may also include training a ML model based upon the randomly selected random locations from each cluster. The ML model may be trained to predict a location and/or a rate of the gas leak using a set of features. The set of features may be or include simulated measurements from the simulated sensors. The third optimization strategy may also include running a recursive feature selection algorithm on the simulated measurements to determine the number of the simulated sensors and/or the locations of the simulated sensors.

### Sensor Planning Workflow

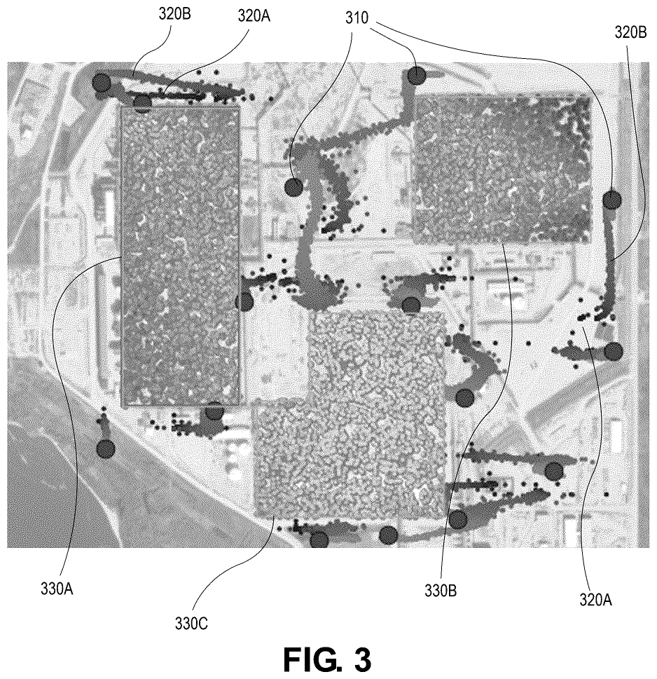

FIG. 3 illustrates a plan view showing the sensor planning workflow (e.g., step 215), according to an embodiment. Here, the solution may be found by a global optimizer and then enhanced by a local optimizer. Optimal placement of the sensors may be shown by the large circles 310. The smaller circles 320A, 320B represent optimization trajectories. The darker shades of the smaller circles 320A correspond to lower qualities of placement, and the lighter shades of the smaller circles 320B correspond to higher qualities of placement. The equipment 330A-330C may be covered by point sources. Areas of the equipment 330A-330C with lighter shading represent a high ability to detect the leak from them, and areas of the equipment 330A-330C with darker shading represent a lower ability to detect the leak from them.

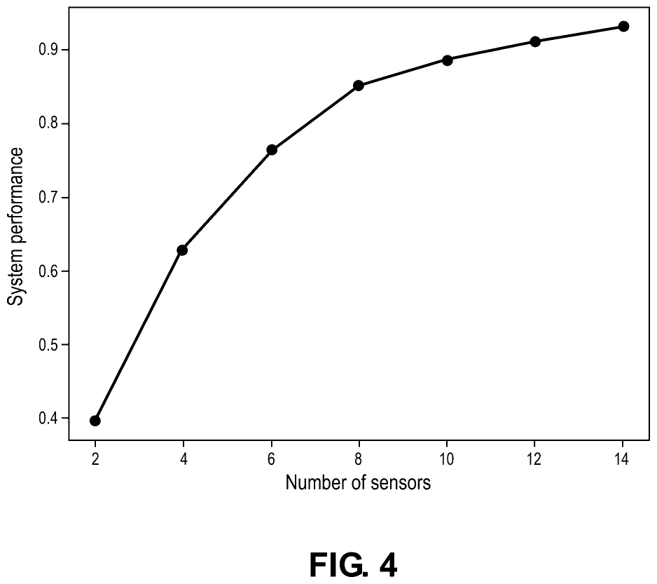

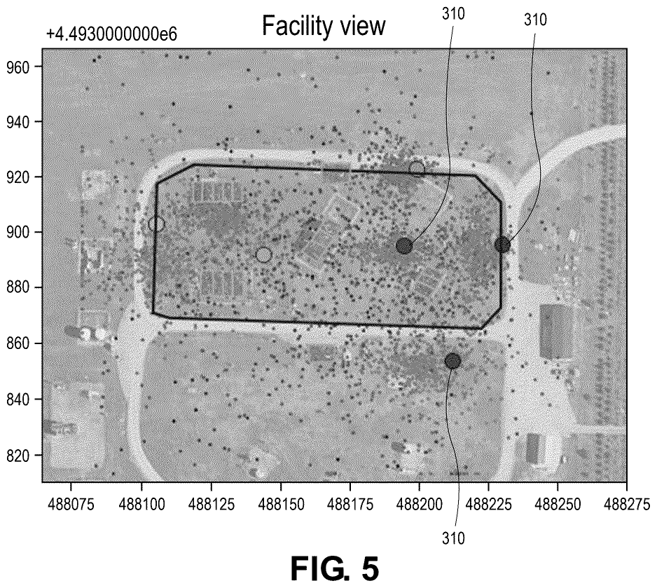

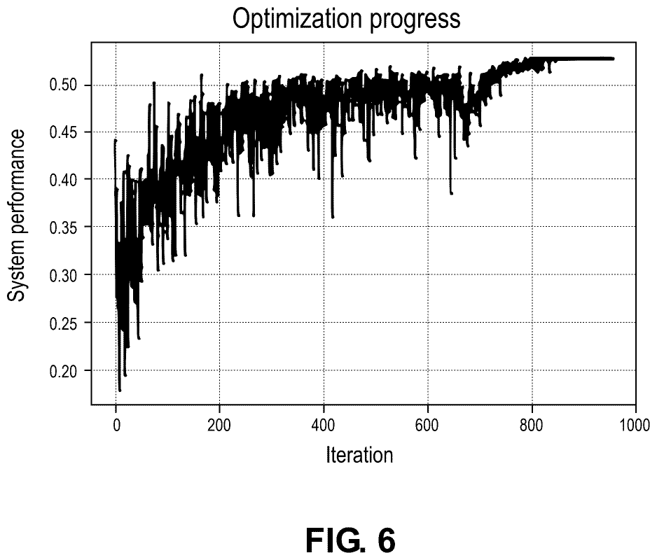

Referring back to FIG. 2, the method 200 may also include displaying the accuracy of detecting the gas leak for each iteration, as at 220. FIG. 4 illustrates an example chart displaying the accuracy versus the number of the simulated sensors, according to an embodiment. FIG. 5 illustrates an example map displaying the (e.g., optimal) locations of the simulated sensors 310, according to an embodiment. FIG. 6 illustrates an example graph showing the progression of the optimization, according to an embodiment. The examples illustrated in FIGS. 4-6 are not limiting, and other examples can also be included.

The method 200 may also include selecting the number of the simulated sensors (e.g., based upon the accuracy), as at 225.

The method 200 may also include selecting the locations of the selected number of the simulated sensors (e.g., based upon an output of the first, second, and/or third optimization strategy), as at 230.

The method 200 may also include positioning the selected number of actual sensors at the selected locations, as at 235.

The method 200 may also include receiving actual measurements from the selected number of the actual sensors at the selected locations, as at 240.

### Physical Dispersion Models

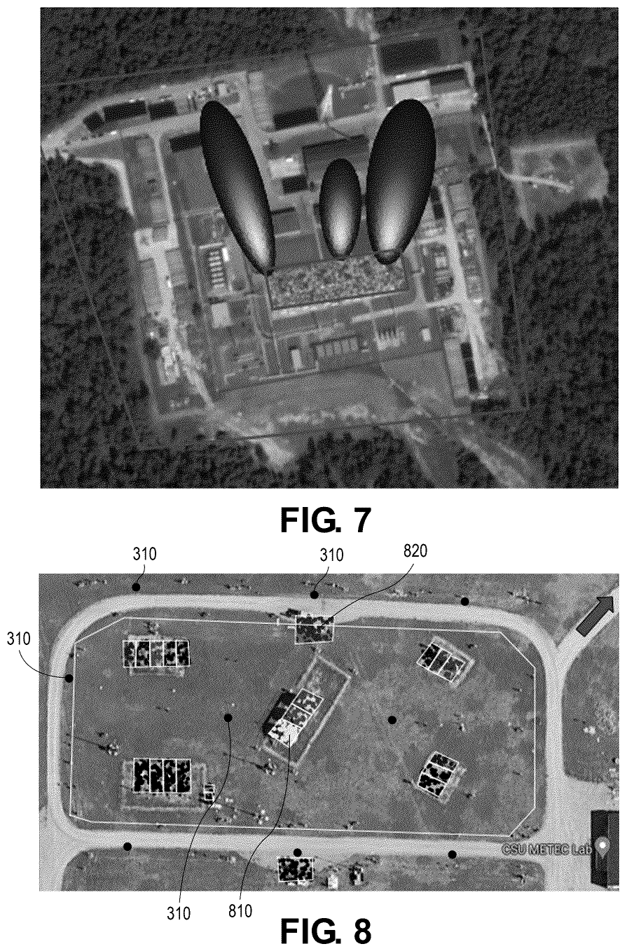

The method 200 may also include generating a plurality of physical dispersion models as at 245. FIG. 7 illustrates a plan view of three physical dispersion models generated from point sources randomly positioned inside delimited areas of potential gas leaks, according to an embodiment. The models may be generated based upon the simulated point sources, a potential rate of the gas leak from the one or more of the simulated point sources, the historical atmospheric conditions, the number of the actual sensors, the locations of the actual sensors, or a combination thereof. Each of the physical dispersion models may have randomly generated initial conditions. The initial conditions may include one or more of the simulated point sources, current atmospheric conditions, the potential rate of the gas leak, or a combination thereof.

The method 200 may also include determining the simulated measurements from the selected number of the actual sensors at the selected locations using the physical dispersion models, as at 250. Self-correlated noise may be added to each of the physical dispersion models and/or the simulated measurements.

The method 200 may also include training a first model (e.g., a ML regression algorithm/model) to predict the location and/or the rate of the gas leak, as at 255. The training may be based upon the simulated measurements and/or the current atmospheric conditions.

### ML Classifier Prediction

The method 200 may also include training a second model (e.g., a ML classifier) to predict a probability that the gas leak is coming from each of the simulated point sources, as at 260. The training may be based upon the simulated measurements and/or the current atmospheric conditions. FIG. 8 illustrates a plan view of a prediction from the ML classifier showing probabilities of leak source locations, according to an embodiment. Lighter shading 810 represents higher probabilities of leak locations, and darker shading 820 represents lower probabilities.

The method 200 may also include predicting the location and/or the rate of the gas leak using the trained ML regression algorithm and/or the trained ML classifier, as at 265. The predicted location and/or the predicted rate may be based upon the actual measurements. Predicting the location and/or the rate may include determining probabilities that the location of the gas leak is at each of the simulated point sources.

The method 200 may also include displaying the predicted location and/or the predicted rate of the gas leak, as at 270.

The method 200 may also include performing an action in response to the predicted location and/or the predicted rate of the gas leak, as at 275. The action may be or include generating and/or transmitting a signal that instructs and/or causes a physical action to occur. The physical action may be or include shutting off the gas and/or fixing (e.g., sealing and/or repairing) the gas leak.

### Exemplary Computing System

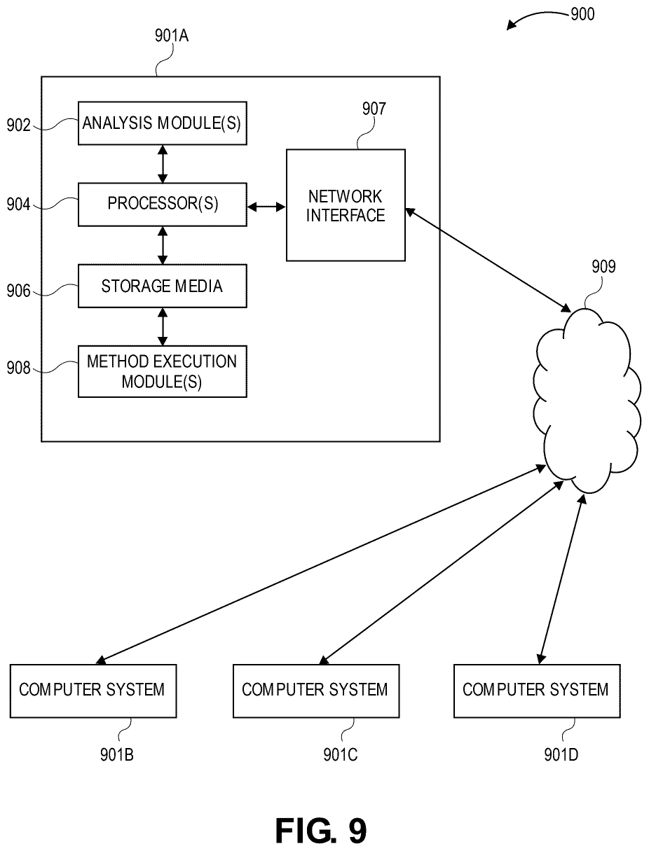

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 900 contains one or more method execution module(s) 908. In the example of computing system 900, computer system 901A includes the method execution module 908. In some embodiments, a single method execution module may be used to perform some aspects of one or more embodiments of the methods disclosed herein. In other embodiments, a plurality of method execution modules may be used to perform some aspects of methods herein.

It should be appreciated that computing system 900 is merely one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for detecting a gas leak, the method comprising:
selecting locations for a plurality of simulated point sources of the gas leak at a site;
generating a plurality of physical dispersion models based upon the simulated point sources, a selected number of sensors that are configured to detect the gas leak, and selected locations of the sensors;
determining simulated measurements from the sensors at the selected locations using the plurality of physical dispersion models;
training one or more models based upon the simulated measurements;
receiving actual measurements from the selected number of the sensors at the selected locations; and
predicting a location and/or a rate of the gas leak using the one or more trained models based upon the actual measurements.

2. The method of claim 1, wherein the locations of the plurality of simulated point sources are randomly selected inside delimited areas of potential gas leaks, and wherein the gas comprises methane.

3. The method of claim 1, wherein the plurality of physical dispersion models are also generated based upon a potential rate of the gas leak from the one or more of the plurality of simulated point sources.

4. The method of claim 3, wherein each of the plurality of physical dispersion models has randomly generated initial conditions, and wherein the initial conditions comprise one or more of the plurality of simulated point sources, current atmospheric conditions, and the potential rate of the gas leak.

5. The method of claim 1, wherein training the one or more models comprises training a machine learning (ML) regression model to predict the location and the rate of the gas leak based upon the simulated measurements and current atmospheric conditions.

6. The method of claim 1, wherein training the one or more models comprises training a machine learning (ML) classifier to predict a probability that the gas leak is coming from each of the plurality of simulated point sources based upon the simulated measurements and current atmospheric conditions.

7. The method of claim 1, wherein training the one or more models comprises:
training a machine learning (ML) regression model to predict the location and the rate of the gas leak based upon the simulated measurements and current atmospheric conditions; and
training a ML classifier to predict a probability that the gas leak is coming from each of the plurality of simulated point sources based upon the simulated measurements and the current atmospheric conditions.

8. The method of claim 1, wherein predicting the location and/or the rate of the gas leak comprises determining probabilities that the location of the gas leak is at each of the plurality of simulated point sources.

9. The method of claim 1, further comprising displaying the predicted location and/or the predicted rate of the gas leak.

10. The method of claim 1, further comprising performing an action to remedy the gas leak in response to the predicted location and/or the predicted rate of the gas leak, wherein the action comprises shutting off the gas and/or sealing the gas leak.

11. A computing system, comprising:
one or more processors; and
a memory system comprising one or more non-transitory computer-readable media storing instructions that, when executed by at least one of the one or more processors, cause the computing system to perform operations, the operations comprising:
selecting locations for a plurality of simulated point sources of a gas leak at a site;
generating a plurality of physical dispersion models based upon the plurality of simulated point sources, a potential rate of the gas leak from the one or more of the plurality of simulated point sources, a selected number of actual sensors that are configured to detect the gas leak, and selected locations of the actual sensors;
determining simulated measurements from the actual sensors at the selected locations using the plurality of physical dispersion models;
training a machine learning (ML) regression algorithm to predict a location and/or a rate of the gas leak based upon the simulated measurements and the current atmospheric conditions;
training a ML classifier to predict a probability that the gas leak is coming from each of the plurality of simulated point sources based upon the simulated measurements and the current atmospheric conditions;
receiving actual measurements from the selected number of the actual sensors at the selected locations; and
predicting the location and/or the rate of the gas leak using the trained ML regression algorithm and the trained ML classifier, wherein the predicted location and/or the predicted rate are based upon the actual measurements.

12. The computing system of claim 11, wherein the operations further comprise performing a plurality of simulated iterations to determine an accuracy of detecting the gas leak at the site with a plurality of simulated sensors, wherein each iteration is performed with a different number of the simulated sensors and/or different locations of the simulated sensors, and wherein the accuracy is determined based upon the plurality of simulated point sources.

13. The computing system of claim 12, wherein the operations further comprise receiving historical atmospheric conditions at the site, wherein the historical atmospheric conditions comprise wind speed, wind direction, and solar irradiation, and wherein the accuracy is also determined based upon the historical atmospheric conditions.

14. The computing system of claim 12, wherein the selected number of the actual sensors is selected based upon the accuracy.

15. The computing system of claim 12, wherein the operations further comprise displaying the accuracy of detecting the gas leak for each iteration, wherein a chart displays the accuracy versus the number of the simulated sensors, and wherein a map displays the locations of the simulated sensors.

16. A non-transitory computer-readable medium storing instructions that, when executed by one or more processors of a computing system, cause the computing system to perform operations, the operations comprising:
selecting locations for a plurality of simulated point sources of a gas leak at the site, wherein the locations of the plurality of simulated point sources are randomly selected inside delimited areas of potential gas leaks, wherein the site comprises a facility or a wellsite, wherein the gas comprises methane;
receiving historical atmospheric conditions at the site, wherein the historical atmospheric conditions comprise wind speed, wind direction, and solar irradiation;
performing a plurality of simulated iterations to determine an accuracy of detecting the gas leak at the site with a plurality of simulated sensors, wherein each iteration is performed with a different number of the simulated sensors and/or different locations of the simulated sensors, wherein the accuracy is determined based upon the plurality of simulated point sources and the historical atmospheric conditions, wherein the simulated sensors are located along and/or inside a perimeter of the site, wherein the locations of the simulated sensors are determined in one dimension when the locations of the simulated sensors are exclusively along the perimeter, wherein the locations of the simulated sensors are determined in two dimensions when one or more of the simulated sensors are located inside the perimeter;
displaying the accuracy of detecting the gas leak for each iteration, wherein a chart displays the accuracy versus the number of the simulated sensors, and wherein a map displays the locations of the simulated sensors;
selecting the number of the simulated sensors based upon the accuracy;
selecting the locations of the selected number of the simulated sensors based upon an optimization strategy;
positioning the selected number of actual sensors at the selected locations;
receiving actual measurements from the selected number of the actual sensors at the selected locations;
generating a plurality of physical dispersion models based upon the plurality of simulated point sources, a potential rate of the gas leak from the one or more of the plurality of simulated point sources, the historical atmospheric conditions, the number of the actual sensors, and the locations of the actual sensors, wherein each of the plurality of physical dispersion models has randomly generated initial conditions, wherein the initial conditions comprise one or more of the plurality of simulated point sources, current atmospheric conditions, and the potential rate of the gas leak;
determining simulated measurements from the actual sensors at the selected locations using the plurality of physical dispersion models, wherein self-correlated noise is added to each of the plurality of physical dispersion models and/or the simulated measurements;
training a machine learning (ML) regression algorithm to predict a location and/or a rate of the gas leak based upon the simulated measurements and the current atmospheric conditions;
training a ML classifier to predict a probability that the gas leak is coming from each of the plurality of simulated point sources based upon the simulated measurements and the current atmospheric conditions;
predicting the location and/or the rate of the gas leak using the trained ML regression algorithm and the trained ML classifier, wherein the predicted location and the predicted rate are based upon the actual measurements, and wherein predicting the location and the rate comprises determining probabilities that the location of the gas leak is at each of the plurality of simulated point sources; and
displaying the predicted location and the predicted rate of the gas leak.

17. The non-transitory computer-readable medium of claim 16, wherein the number of the simulated sensors and the locations of the simulated sensors are determined by:
running an optimizer based upon the locations of the plurality of simulated point sources and the historical atmospheric conditions, wherein the optimizer is run to identify a global optimum of multi-dimensional target functions, and wherein running the optimizer comprises:
determining a surrogate statistical target, wherein the surrogate statistical target comprises a number of non-null readings from the simulated sensors and/or a degree of cross-correlation in readings from the simulated sensors; and
switching the surrogate statistical target to a reduced regressor or classifier ML model;
determining a predetermined number of solutions of the number of the simulated sensors and the locations of the simulated sensors from the reduced regressor or the classifier ML model once global optimization has converged or reached a runtime limit; and
running the predetermined number of solutions through ML validation, wherein the number of the simulated sensors and the locations of the simulated sensors are determined based upon the ML validation.

18. The non-transitory computer-readable medium of claim 16, wherein the number of the simulated sensors and the locations of the simulated sensors are determined by:
generating a predetermined number of the simulated sensors at random locations;
determining the accuracy detecting the gas leak for each of the predetermined number of the simulated sensors at the random locations;
determining a predetermined number of the random locations based upon the accuracy;
enhancing each of the predetermined number of the random locations using a local optimizer; and
validating each of the enhanced predetermined number of the random locations using the reduced regressor or the classifier ML model, wherein the number of the simulated sensors and the locations of the simulated sensors are determined based upon the validation of each of the enhanced predetermined number of the random locations.

19. The non-transitory computer-readable medium of claim 16, wherein the number of the simulated sensors and the locations of the simulated sensors are determined by:
generating a predetermined number of the simulated sensors at random locations;
determining a similarity measure for the random locations;
performing hierarchical clustering on the random locations, wherein the hierarchical clustering is performed with a number of clusters that is smaller than the predetermined number of the simulated sensors;
randomly selecting one of the random locations from each cluster;
training a ML model based upon the randomly selected random locations from each cluster, wherein the ML model is trained to predict a location and/or a rate of the gas leak using a set of features, and wherein the set of features comprises simulated measurements from the simulated sensors; and
running a recursive feature selection algorithm on the simulated measurements to determine the number of the simulated sensors and the locations of the simulated sensors.

20. The non-transitory computer-readable medium of claim 16, wherein the operations further comprise performing an action in response to the predicted location and the predicted rate of the gas leak, wherein the action comprises generating or transmitting a signal that instructs or causes the gas leak to be remedied by shutting off the gas and/or fixing the gas leak.
